(19) United States
(12) Patent Application Publication
(10) Pub. No.: US 2007/0139386 A1
(43) Pub. Date: Jun. 21, 2007

(54) Touch screen user interface for digital reprographic device with pop-up menu display

(75) Inventors: Andrew T. Martin, Honeoye Falls, NY (US); Marc J. Krolczyk, Spencerport, NY (US)

Correspondence Address: Min, Hsieh & Hack LLP, Suite 630, 8270 Greensboro Drive, McLean, VA, 22102, US

(73) Assignee: Xerox Corporation

(21) Appl. No.: 11/304,654

(22) Filed: Dec. 16, 2005

(51) Int. Cl. G09G 5/00

(52) U.S. Cl. 345/173

(57) ABSTRACT

Embodiments of the present invention provide methods, apparatus, and systems for an efficient user interface implemented on a touch screen for a digital reprographic machine. In particular, the touch screen may display various objects, such as icons or command buttons. In response to a user selecting one of these objects, a pop-up window is then provided on the touch screen. The pop-up window may comprise a list box or menu and its contents may be determined by the functions corresponding to the selected object. The pop-up window may remain open until the user selects one of the items, or touches an area of the touch screen that is outside of the pop-up window, or after a certain amount of time has elapsed, such as 10-15 seconds. When the user touches an item in the pop-up window, the pop-up window may close and a corresponding operation may be performed by the digital printing machine.

### FIELD OF THE INVENTION

The present invention is directed to user interfaces, and more specifically, to a touch screen user interface that provides pop-up windows.

### BACKGROUND OF THE INVENTION

Digital printing machines or copiers are widely used in offices and printing shops. To simplify their operation, a copier typically includes a touch screen that provides a user interface (UI). However, copier touch screens are generally quite small in size, which limits the amount of information provided by the UI at any one time. For example, known copier touch screens usually provide a small number of dedicated command buttons on their touch screen. Unfortunately, this UI scheme consumes a large amount of the available space on the touch screen and requires a deep hierarchy of menus and windows, which can be difficult for a user to navigate.

Accordingly, it may be desirable to provide methods, apparatus, and systems that efficiently use the available space on a touch screen. It may also be desirable to provide a UI that assists the users in navigating through the various options and commands needed to operate devices, such as copiers.

### SUMMARY OF THE INVENTION

In accordance with one feature of the invention, a method of interfacing with a touch screen of a digital reprographic device is provided. A set of selectable objects is displayed for controlling the operation of the digital reprographic device on a touch screen. When contact with the touch screen is sensed, a position of the contact with the touch screen is determined and one of the selectable objects is selected based on the position of the contact with the touch screen. A pop-up window is then displayed and comprises a set of selectable items that correspond to the selected object.

In accordance with another feature of the present invention, a touch screen user interface for a digital reprographic device is provided. The touch screen displays a set of selectable objects and is configured to indicate a location of contact. A user interface controller is configured to determine a position of the contact with the touch screen, select one of the set of selectable objects based on the position of the contact, and display a pop-up window comprising selectable items related to the selected object.

In accordance with another feature of the present invention, a multi-function digital reprographic machine comprises a printer, a scanner, and a touch screen for displaying a set of selectable objects and configured to indicate a location of contact. A user interface controller is configured to determine a position of the contact with the touch screen, select one of the set of selectable objects based on the position of the contact, and display a pop-up window comprising selectable items related to the selected object.

Additional features will be set forth in part in the description which follows, and in part will be obvious from the description, or may be learned by practice of the invention. The features of the invention will be realized and attained by means of the elements and combinations particularly pointed out in the appended claims.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 depicts an exemplary digital reprographic machine that is consistent with embodiments of the present invention;

FIG. 2 depicts a block diagram of an exemplary hardware environment of the machine shown in FIG. 1 that is consistent with embodiments of the present invention;

FIG. 3 depicts an exemplary structure of a touch screen that is in accordance embodiments of the present invention;

FIG. 4 depicts a screen shot diagram of an exemplary touch screen including selectable objects that is in accordance with embodiments of the present invention;

FIG. 5 depicts a screen shot diagram of an exemplary touch screen including selectable objects and a pop-up window that is in accordance with embodiments of the present invention; and

FIG. 6 depicts a flow diagram illustrating the processing of the user controller of the machine shown in FIG. 1 consistent with embodiments of the present invention.

### DESCRIPTION OF THE EMBODIMENTS

Embodiments of the present invention provide methods, apparatus, and systems for an efficient UI implemented on a touch screen for a digital reprographic machine. In particular, the touch screen may display various objects, such as icons or command buttons. In response to a user selecting one of these objects, a pop-up window is then provided on the touch screen. The pop-up window may comprise a list box or menu and its contents may be determined by the functions corresponding to the selected object. Other items may also appear as the pop-up window, such as a message or various sets of selections. The pop-up window may remain open until the user selects one of the items, or touches an area of the touch screen that is outside of the pop-up window, or after a certain amount of time has elapsed, such as 10-15 seconds. When the user touches an item in the pop-up window, the pop-up window may close and a corresponding operation may be performed by the digital printing machine.

Reference will now be made in detail to the exemplary embodiments of the invention, examples of which are illustrated in the accompanying drawings. Wherever possible, the same reference numbers will be used throughout the drawings to refer to the same or like parts.

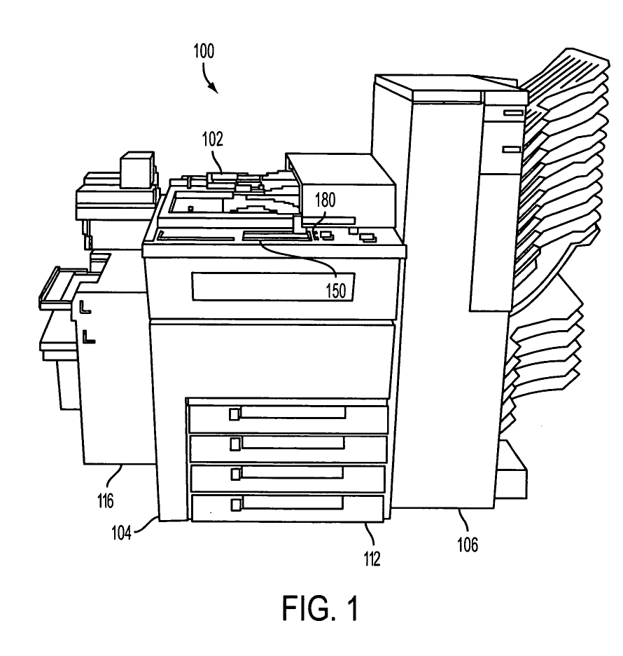

Embodiments of the present invention may be applied to a variety of digital reprographic machines, such as a copier, or a multifunction copier/scanner. FIG. 1 depicts an exemplary digital reprographic machine 100, consistent with embodiments of the present invention. As shown, the digital machine 100 includes a scanning device 102, a printing module 104, and a touch screen user interface 150. The digital machine 100 may also include a finisher device 106 which may be a sorter, tower mailbox or stapler. The printing module 104 may include a plurality of paper trays 112 that store paper used in the printing process. The digital machine may also include a high capacity feeder 116, which is capable of holding large amounts of paper stock to be used by the machine.

In a typical scanning function, the operator would utilize the scanning device 102 to scan in the images from the original documents. This scanning device 102 may be a platen type scanner or may include a constant velocity transport system which moves the original documents across a stationary scanning device. Moreover, the scanning device 102 may also include a document handling system, which is capable of placing the original documents, automatically, on the glass platen for scanning.

With respect to the printing functions, the printing module 104 would retrieve the proper paper from one of the multiple paper trays 112 or the high capacity feeder 116, render the desired image on the retrieved paper, and output the printed image to the finishing device 106 for further operations.

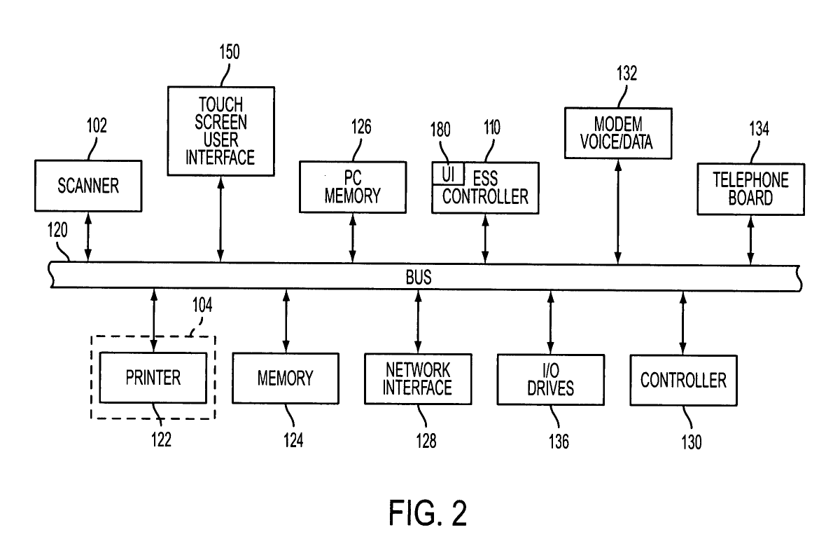

FIG. 2 depicts a block diagram of an exemplary hardware environment of a reprographic machine 100. For purposes of illustration, machine 100 is shown comprising a scanner 102, printer 104, ESS controller 110, a memory 124, a pre-collation memory 126, a network interface 128, a network controller 130, a modem 132, a telephone board 134, I/O drives 136, touch screen 150, and a UI controller 180. These components may be coupled together via bus 120. Bus 120 may be a single bus or a plurality of buses, which provide interconnections and intercommunications between the various components of machine 100. One skilled in the art will also recognize that machine 100 may include other components.

Scanner 102 converts an original image into a set of digital signals that can be either stored or reproduced. As noted, scanner 102 may be a platen type scanner or may include a constant velocity transport system.

Printing module 104 converts digital signals representing an image into a hardcopy of that image on a recording medium, such as paper, a transparency, or other type of markable medium. Printing module 104 may further comprise a digital printing device 122 and a memory 124.

Digital printing device 122 may render the image onto the hardcopy medium. Memory 124 is provided for storing a variety of types of digital information, such as machine fault information, machine history information, digital images to be processed at a later time, instruction sets for the machine or job instruction sets.

Machine 100 may also include a pre-collation memory 126 to assist the operation of printer 102. For example, pre-collation memory 126 may store a digital representation of the image being presently rendered by the digital printing device 122. In particular, in electronic pre-collation memory 126, the digital image may already be laid out in its page structure so that it can be readily rendered by the digital printing device 122.

Electronic subsystem (ESS) controller 110 controls the functions and operations of the components shown in FIG. 2. For example, controller 110 may control the operations of scanner 102 or printer 104. A user may operate touch screen user interface 150 to enter various commands. These commands may then be passed to ESS controller 110. User interface controller 180 within ESS controller 110 may interpret the commands from user interface 150 and provide appropriate data to the other components of machine 100 via bus 120.

Since digital machine 100 may be connected to a network (not shown), it may also include network interface 128 and network controller 130. These components may control the interrelationship between the various modules or stations on the digital machine 100 and communications to/from the network (not shown). The network may be implemented as a wide area network (WAN), local area network (LAN), an intranet and/or the Internet.

Since machine 100 may be a multi-function machine, it may also include a voice/data modem 132 and/or a telephone circuit board 134. These components may be used to interface with machine 100 to a telephone network.

Machine 100 may also include additional storage, such as input/output (I/O) drives 136. I/O drives 136 may be implemented as well known devices, such as a floppy disc drive, a CD ROM drive, a tape drive, or other type of drive which can accept a portable memory device.

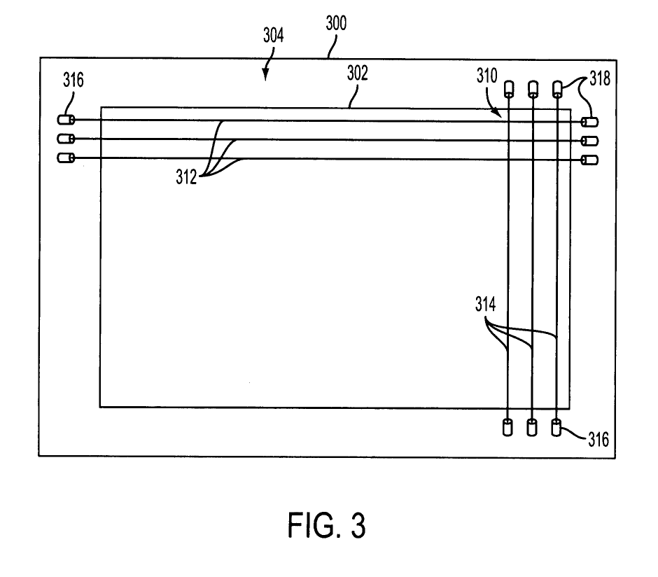

FIG. 3 depicts an exemplary structure of a touch screen for machine 100 that is in accordance embodiments of the present invention. One skilled in the art will recognize that embodiments of the present invention may be applied to any type of touch screen. As shown, a touch screen 300 includes a touch sensitive display 302 and a touch sensor 304. Touch sensor 304 may include an array of light sources 316 and photodetectors 318. A rectangular grid 310 is formed by the intersection of horizontal light beams 312 and vertical light beams 314. Light, in the visible or infrared spectrum, emanating from light sources 316, is directed towards photodetectors 318 located on sides opposite light sources 316. Thus, light sources 316 and photodetectors 318 may form distinct light source-photodetector pairs, hereinafter referred to as source-detector pairs.

The light beams defined by the source-detector pairs are used to detect where touch screen 300 has been touched based on the presence of a user's finger, or other such probe, in close proximity to touch screen 300. When touch screen 300 is touched, one or more light beams are interrupted and the corresponding photodetectors are unable to detect the light beam which is normally incident upon it. The lack of an incident light beam causes the photodetector to alter its output signal, thereby indicating the location of where the touch screen is being touched.

User interface controller 180 processes the photodetector signals to provide an indication that touch screen 300 has been touched, as well as the coordinate center position of where touch screen 300 has been touched. During operation, user interface controller 180 may interpret that an object on touch screen 300 has been selected when touching of touch screen 300 has ended, so that the last touched item is the selected one. In addition, when user interface controller 180 has detected touching of touch screen 300, it may provide concurrent feedback, such as a visual indicator (including, but not limited to the display of a cross-hair, arrow, or cursor-like image) or an audible indicator (including but not limited to: a simple tone, a complex tone, a musical note, a sequence of notes, a buzzer sound, a bell sound, a click sound).

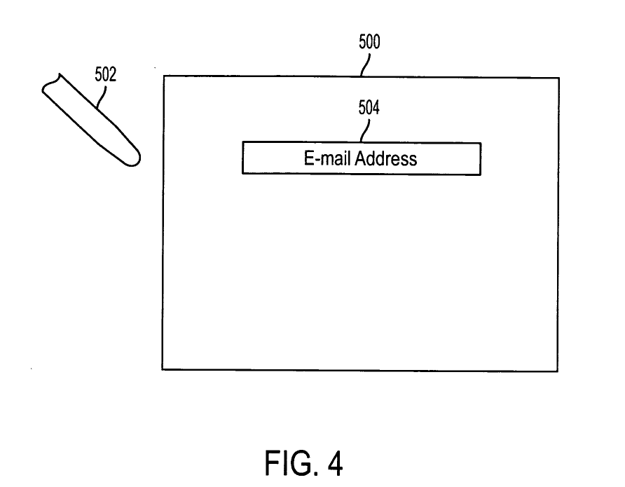

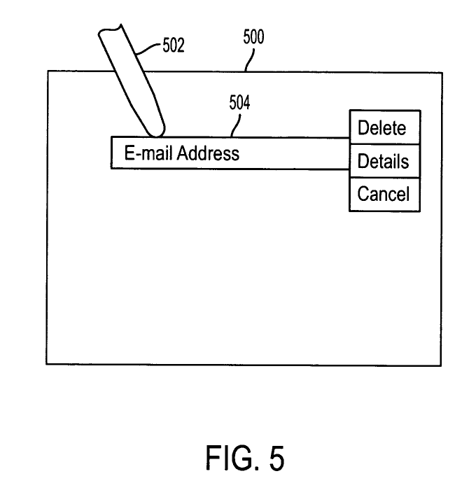

FIGS. 4 and 5 each depict screen shot diagrams to illustrate the interface techniques that are in accordance with embodiments of the present invention. Referring now to FIG. 4, an initial display 500 may include one or more command buttons, such as an object 504. Object 504 may be any element of UI 150 that displays information or provides a specific way for a user to interact with ESS controller 110 and control the operations of machine 100. For example, object 504 may be a simple icon, a widget, and the like. For purposes of simplicity, display 500 is shown with a single object. However, one skilled in the art will recognize that display 500 may include any number of selectable objects.

As shown, a user can select object 504 using a probe 502, such as the user's finger or other suitable implement. Object 504 may represent any selectable object that includes a menu associated with it, such as, configuration settings, paper selections, email addresses, file types, compression sizes, color output, etc. Additional selectable objects are well known to those skilled in the art. Other examples include objects related to print jobs in a print queue, files in a container such as a folder, users or user accounts, and the like. Once the user has selected object 504, display 500 may then include a pop-up window 506, which in this example appears in the form of a pop-up menu.

For example, as depicted in FIG. 5, upon selection of object 504, a pop-up window 506 may appear as a pop-up menu and include items that represent functions determined by the object that is selected. These items may be mutually exclusive and may be context sensitive to when and where object 504 has been selected. For example, upon selection of object 504, touch screen 500 may display a pop-up window 506 including menu items calling for functions related to the email address such as “Delete”, “Details”, Add, and “Edit”. Alternately, if the user selected a job in a print queue some options presented in the menu of pop-up window 506 may be, “Hold”, “Release”, “Promote”, “Edit”, “Delete”, “Details”.

A user may then select one of the items shown in pop-up window 506. User interface controller 180 then closes pop-up window 506 and performs the function associated with the selected menu item. In one embodiment, pop-up window 506 may disappear upon an expiration signal, such as a predetermined amount of time (for example 10 seconds) or probe 502 contacting touch screen 500 in a space outside pop-up window 506.

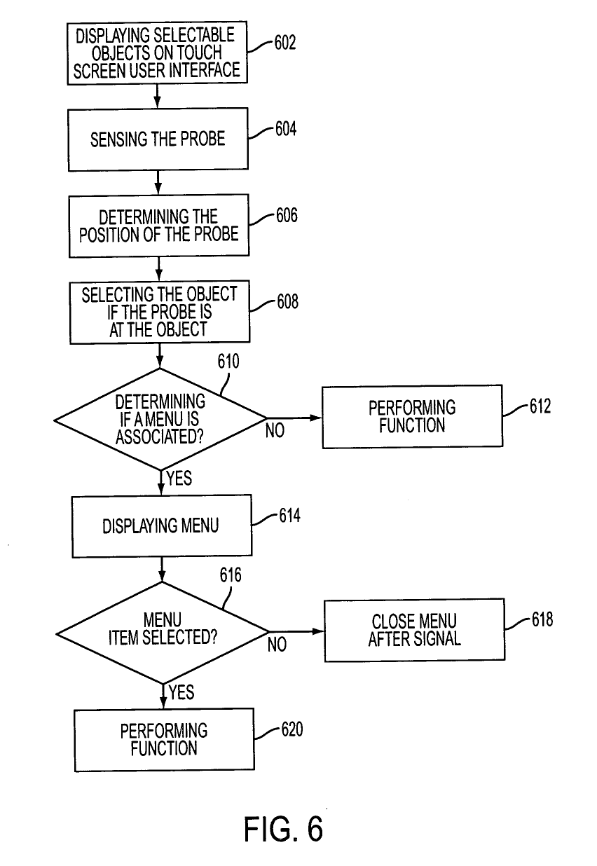

FIG. 6 depicts a flow diagram illustrating the processing of user controller 180 consistent with embodiments of the present invention. The flow diagram will be described with reference to the embodiment of the system depicted in FIG. 2. First, user interface controller 180 displays (step 602) selectable objects on touch screen user interface 150. A probe, such as a user's finger, touches touch screen user interface 150 and user interface controller 180 senses (step 604) the probe and determines (step 606) the position of the probe based on a signal or signals from touch sensor 304 (FIG. 3) as described above regarding FIG. 3. If the position of the probe is at an object, user interface controller 180 selects (step 608) the object as described above regarding FIG. 3. Upon selection of the object, user interface controller 180 determines (step 610) if the selected object includes a menu associated with it. If user interface controller 180 determines the selected object does not have a menu associated with it, (step 612) user interface controller 180 performs the function associated with the selected object. If user interface controller 180 determines the selected object has a menu associated with it, user interface controller 180 displays a menu consisting of items representing functions that may be related to the object that is selected as described above regarding FIGS. 4 and 5 (step 608). If the user selects a menu item (step 616), user interface controller 180 closes pop-up window 506 and performs (step 620) the function associated with the menu item 620, as described above regarding FIGS. 4 and 5. If the user does not select a menu item (step 616), user interface controller 180 closes (step 618) the menu upon an expiration signal. User interface controller 180 triggers an expiration signal upon a predetermined lapse of time such as, for example, 10 seconds. In another embodiment, user interface controller 180 triggers an expiration signal upon the probe contacting touch screen user interface 150 in a space outside the menu. If the user does select a menu item (step 616), user interface controller 180 performs (step 620) a function associated with the menu item.

Other embodiments of the invention will be apparent to those skilled in L the art from consideration of the specification and practice of the invention disclosed herein. It is intended that the specification and examples be considered as exemplary only, with a true scope and spirit of the invention being indicated by the following claims.

1. A method of interfacing with a touch screen of a digital reprographic device, said method comprising:
displaying a set of selectable objects for controlling the operation of the digital reprographic device on a touch screen;
sensing contact with the touch screen;
determining a position of the contact with the touch screen;
selecting one of the selectable objects based on the position of the contact with the touch screen; and
displaying a pop-up window comprising a set of selectable items that correspond to the selected object.

2. The method of claim 1, wherein each of the set of selectable items corresponds to a function of the digital reprographic device.

3. The method of claim 1, wherein each function is mutually exclusive.

4. The method of claim 1 further comprising closing the pop-up window upon based on when the contact with the touch screen has ended.

5. The method of claim 1 further comprising closing the pop-up window after a predetermined amount of time.

6. The method of claim 1 further comprising closing the pop-up window upon based on when contact on the touch screen in an area outside the menu.

7. A touch screen user interface for a digital reprographic device, said touch screen user interface comprising:
a touch screen for displaying a set of selectable objects and configured to indicate a location of contact; and
a user interface controller configured to determine a position of the contact with the touch screen, select one of the set of selectable objects based on the position of the contact, and display a pop-up window comprising selectable items related to the selected object.

8. The touch screen user interface of claim 7, wherein the selectable items are related to functions of the digital reprographic device.

9. The touch screen user interface of claim 7, wherein the selectable items are mutually exclusive.

10. The touch screen user interface of claim 7, wherein the user interface controller is configured to command the digital reprographic device to perform the function associated with one of the set of selectable items in the pop-up window.

11. The touch screen user interface of claim 7, wherein the user interface controller is configured to close the pop-up window after a predetermined amount of time.

12. The touch screen user interface of claim 7, wherein the user interface controller is configured to close the pop-up window upon contact in an area of the touch screen outside the pop-up window.

13. A multi-function digital reprographic machine comprising:
a printer;
a scanner;
a touch screen for displaying a set of selectable objects and configured to indicate a location of contact; and
a user interface controller configured to determine a position of the contact with the touch screen, select one of the set of selectable objects based on the position of the contact, and display a pop-up window comprising selectable items related to the selected object.

14. The multi-function digital reprographic machine of claim 13, wherein the selectable items are related to functions of the digital reprographic device.

15. The multi-function digital reprographic machine of claim 13, wherein the selectable items are mutually exclusive.

16. The multi-function digital reprographic machine of claim 13, wherein the user interface controller is configured to command the digital reprographic device to perform the function associated with one of the set of selectable items in the pop-up window.

17. The multi-function digital reprographic machine of claim 13, wherein the user interface controller is configured to close the pop-up window after a predetermined amount of time.

18. The multi-function digital reprographic machine of claim 13, wherein the user interface controller is configured to close the pop-up window upon contact in an area of the touch screen outside the pop-up window.
